(19) United States
(12) Patent Application Publication
(10) Pub. No.: US 2013/0117154 A1
(43) Pub. Date: May 9, 2013

(54) Method and System of Evaluating Credibility of Online Trading User

(71) Applicant: Yaming Zhou, Hangzhou (CN)

(72) Inventor: Yaming Zhou, Hangzhou (CN)

(73) Assignee: ALIBABA GROUP HOLDING LIMITED, Grand Cayman (KY)

(21) Appl. No.: 13/258,348

(22) PCT Filed: Jun. 29, 2011
(86) PCT No.: PCT/US11/42421

§ 371 Date: Sep. 21, 2011

(30) Foreign Application Priority Data
Jul. 23, 2010 (CN) 201010237866.6

(51) Int. Cl. G06Q 30/06

(52) U.S. Cl. CPC G06Q 30/0609
USPC 705/26.35

(57) ABSTRACT

Evaluating credibility of an online trading user includes, based on a user to be evaluated, querying reference users corresponding to the user to be evaluated. The reference users include trading users who have conducted a transaction with the user to be evaluated and may be obtained from a referenced transaction record of the user to be evaluated. Property information of the reference users may be obtained, and a credibility evaluation result for the user to be evaluated may be generated based on the property information of the reference users and a proportion of all transactions conducted between the user to be evaluated and the reference users for which sales transactions account.

### CROSS REFERENCE TO RELATED PATENT APPLICATIONS

This application is a national stage application of an international patent application PCT/US11/42421, filed Jun. 29, 2011, which claims priority to Chinese Patent Application No. 201010237866.6, filed on Jul. 23, 2010, entitled “Method and System of Evaluating Credibility of Online Trading User,” which applications are hereby incorporated by reference in their entirety.

### TECHNICAL FIELD

The present disclosure relates to the Internet technology field, and particularly, methods and systems of evaluating credibility of an online trading user.

### BACKGROUND

Along with the Internet development, electronic commerce has gradually become a new mode of business operations. The earliest form of e-commerce is online shopping. However, since actual products are not seen during online shopping and quality of the products is varied, buyers are vulnerable to fraud. In view of this, e-commerce websites have launched a credibility system in order to reduce the risk of shopping. The earliest credibility system of an e-commerce website conducted evaluation based on registration information and historical transaction information of sellers. Thereafter, certain other references such as previous transaction history are added. As a result, a buyer may select and conduct a transaction with a seller who has a high credibility level according to credibility levels of the sellers evaluated by the website.

However, along with the continuous development of models and technologies of e-commerce, existing e-commerce is no longer a mere shopping website, but includes other functional websites such as various types of payment websites including Alipay®, offered by ALIBABA GROUP HOLDING LIMITED CORPORATION having a place of business at Grand Cayman, Cayman Islands, and online banking. Therefore, users can conduct more online financial operations such as payments, credit card transactions and cash remittance. Due to this growing number of online financial activities and the over-simplicity of the traditional online credibility evaluation system, malicious users can easily forge certain conditions to meet evaluation criteria of the e-commerce websites in order to improve their credibility levels (i.e., credibility speculation) while avoiding monitoring of the e-commerce websites. The ultimate goal of these malicious users is to conduct such illegal activities as online fraud, money laundering or credit cashing.

Therefore, there is a need for a new online credibility evaluation system.

### SUMMARY

The exemplary embodiments are directed to a method and a system of evaluating credibility of an online trading user more effectively and accurately than existing techniques.

A technical scheme provided in the present disclosure includes a method of evaluating credibility of an online trading user. The method of evaluating credibility of the online trading user includes, based on a user to be evaluated, querying reference users corresponding to the user to be evaluated, the reference users including trading users who have conducted transactions with the user to be evaluated which are obtained from a referenced transaction record of the user to be evaluated. Property information of the reference users is obtained and a credibility evaluation result for the user to be evaluated is generated based on the property information of the reference users and a proportion of all transactions conducted between the user to be evaluated and the reference users for which sales transactions account.

Querying the reference users corresponding to the user to be evaluated includes extracting a time segment as the referenced transaction record from a historical transaction record of the user to be evaluated.

The property information includes a time of registration of a user in a transaction website, a status of identity verification of the user, number of transactions associated with a registered account of the user, and/or a transaction amount associated with the registered account of the user.

The method further includes generating a base score for each reference user from respective property information of the reference users.

Generating the credibility evaluation result for the user to be evaluated based on the property information of the reference users and the proportion of all the transactions conducted between the user to be evaluated and the reference users that the sales transactions account for includes generating the credibility evaluation result for the user to be evaluated based on the base scores of the reference users and the proportion of all the transactions conducted between the user to be evaluated and the reference users for which the sales transactions account.

A system of evaluating credibility of an online trading user includes a query unit, configured to query reference users corresponding to a user to be evaluated based on the user to be evaluated. The reference users include trading users who have conducted transactions with the user to be evaluated and are obtained from a referenced transaction record of the user to be evaluated. An acquisition unit is configured to obtain property information of the reference users. An evaluation unit is configured to generate a credibility evaluation result for the user to be evaluated based on the property information of the reference user and a proportion of all transactions conducted between the user to be evaluated and the reference users for which sales transactions account.

The query unit includes an interception sub-unit, configured to extract a time segment as the referenced transaction record from a historical transaction record of the user to be evaluated, and an extraction sub-unit, configured to obtain the trading users who have conducted transactions with the user to be evaluated from the referenced transaction record of the user to be evaluated, the trading users being the reference users corresponding to the user to be evaluated.

The property information includes a time of registration of a user in a transaction website, a status of identity verification of the user, number of transactions associated with a registered account of the user, and/or a transaction amount associated with the registered account of the user.

The system further includes a rating unit configured to generate a base score for each reference user based on respective property information of the reference users.

The evaluation unit is further configured to generate the credibility evaluation result for the user to be evaluated based on the base scores of the reference users and the proportion of all the transactions conducted between the user to be evaluated and the reference users for which the sales transactions account.

As can be seen, the exemplary embodiments query reference users that correspond to a user to be evaluated based on the user to be evaluated, obtain property information of the reference users, and generate a credibility evaluation result of the user to be evaluated based on the property information of the reference users and a proportion of all transactions conducted between the user to be evaluated and the reference users for which sales transactions account. The scheme provided in the exemplary embodiments combine property information of reference users that have a major influence on credibility of a user to be evaluated, and a proportion of all transactions conducted between the user to be evaluated and the reference users that sales transactions account for to generate a credibility evaluation result for the user to be evaluated. The method provided in the exemplary embodiments greatly improves recognition power of fake credibility and hence security of online transactions.

### DESCRIPTION OF DRAWINGS

In order to more clearly understand the technical scheme of the exemplary embodiments of the present disclosure or existing technologies, accompanying figures that are essential for explaining the exemplary embodiments or existing technologies are briefly described below. Understandably, the following figures only constitute a few exemplary embodiments of the present disclosure. Based on these accompanying figures, one skilled in the art can obtain other figures without making any creative effort.

FIG. 1 shows a flow chart illustrating an exemplary method.

FIG. 2 shows a schematic diagram illustrating an exemplary scenario.

FIG. 3 shows a flow chart illustrating another exemplary method.

FIG. 4 shows a structural diagram illustrating an exemplary system.

FIG. 5 shows a structural diagram illustrating a unit described in the exemplary system.

FIG. 6 shows a structural diagram illustrating another exemplary system.

FIG. 7 shows the exemplary system described in FIG. 4-6 in more detail.

### DETAILED DESCRIPTION

In order for one skilled in the art to understand the technical scheme in the present disclosure, the technical scheme in the exemplary embodiments will be described more clearly and completely using the accompanying figures of the exemplary embodiments. Understandably, the exemplary embodiments described herein only constitute parts, but not all, of exemplary embodiments of the present disclosure. Based on the exemplary embodiments of the present disclosure, one skilled in the art can obtain all other exemplary embodiments, which are still within the scope of the present disclosure.

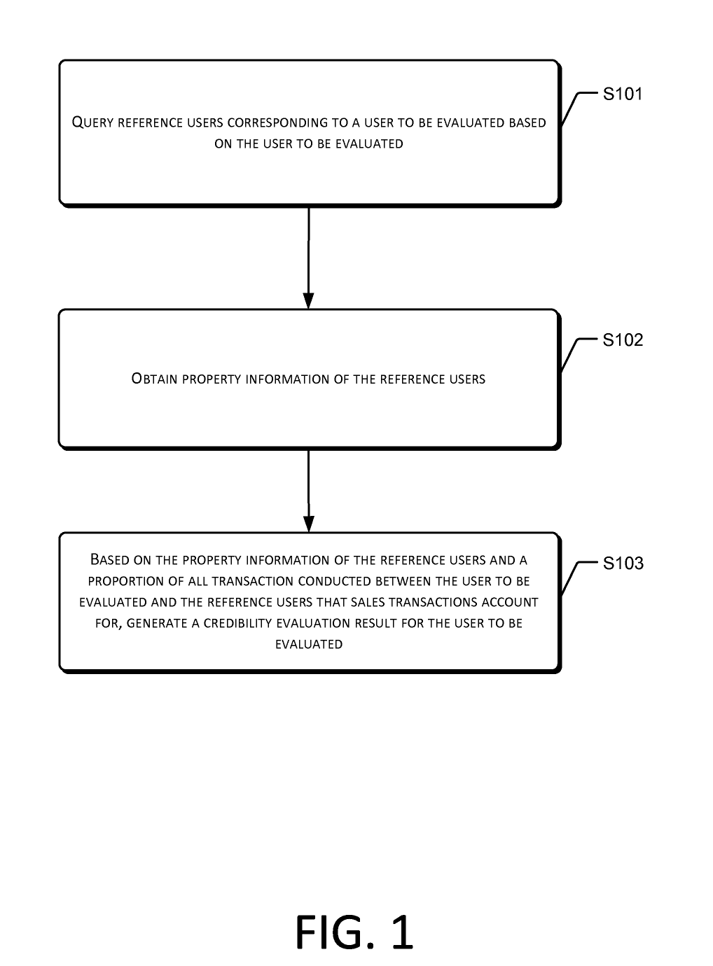

As shown in FIG. 1, in one embodiment, the present disclosure provides a method comprising, at S101, querying reference users corresponding to a user to be evaluated based on the user to be evaluated.

A user to be evaluated may be any transaction entity, e.g., a seller or a buyer. The exemplary method presented in this disclosure has no limitations on a role of the user to be evaluated within a transaction process.

In practice, a reference user corresponding to a user to be evaluated refers to a user who has conducted a transaction with the user to be evaluated. A transaction conducted between the reference user and the user to be evaluated may be a purchase transaction or a sales transaction.

Optionally, all users who have conducted a transaction with the user to be evaluated may be obtained from a transaction history of the user to be evaluated and may be rendered as reference users. Alternatively, past transactions within a certain time segment may be intercepted from the entire transaction history of the user to be evaluated by setting a time interval, e.g., through a time window. For example, for a user having an account 1111, a time window of thirty days may be used to intercept a portion of past transaction record as a referenced transaction record from the transaction history of the account. Trading users who have conducted a transaction with the user to be evaluated may then be obtained from the referenced transaction record. The trading users may be considered to be reference users corresponding to the user to be evaluated.

At S102, the method obtains property information of the reference users.

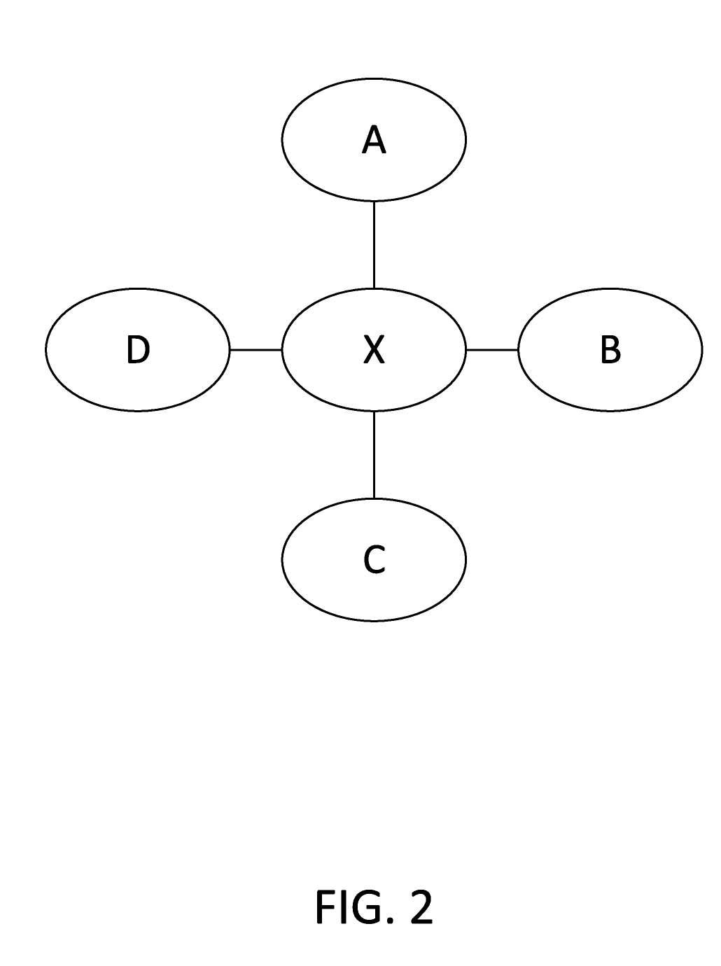

The property information of the reference users refer to property information of online trading users. The reference users possess a relative property. As shown in FIG. 2, X is a user to be evaluated, whereas A, B, C and D are users who have conducted transactions with X within a time window, i.e., reference users of X. When credibility of A is evaluated, A becomes a user to be evaluated and X becomes a reference user of A. As can be seen, a user to be evaluated and a reference user are relative to each other. Both the user to be evaluated and the reference user are entities associated with online transactions and possess property information. In general, in a process of an online transaction, both a buyer and a seller are derived from registered users of an e-commerce website and are involved in online transactions.

The property information of an entity involved in a process of an online transaction may include, for example, a time of registering an account of the transaction entity, information of identity verification of the online transaction entity, number of transactions associated with the account and a transaction amount. The identity verification information of the online transaction entity may include, for example, whether the transaction entity is verified, and details of associated verification method, etc. The present disclosure has no limitation on details of property information of an online transaction entity.

At S103, the method generates a credibility evaluation result for the user to be evaluated based on the property information of the reference users and a proportion of all transactions conducted between the user to be evaluated and the reference users that sales transactions account for.

Transactions between the user to be evaluated and the reference users corresponding to the user to be evaluated include purchase transactions and sales transactions. A purchase transaction refers to purchasing a product of a reference user by the user to be evaluated. A sales transaction refers to selling a product owned by the user to be evaluated to a reference user associated therewith. In a practical application, a purchase transaction is easier to be achieved than a sales transaction, i.e., associated transaction operating cost is small. Therefore, the exemplary method provided in this disclosure employs the property information of the reference users and a proportion of all transactions conducted between the user to be evaluated and the reference users that sales transactions account for to generate a credibility evaluation result for the user to be evaluated.

A proportion of all transactions conducted between the user to be evaluated and the reference users that sales transactions account for may be derived from the proportion of the total number of transactions conducted between the reference users and the user to be evaluated that the sales transactions account for, and/or the proportion of the total monetary amount of transactions that the sales transactions account for.

For instance, a user to be evaluated may have conducted one hundred transactions with reference users, of which sixty are purchase transactions and forty are sales transactions. Therefore, the proportion of the total number of transactions between the user to be evaluated and the references users that the sales transactions account for is 40%. Alternatively, monetary transaction amount associated with the sales transactions is one hundred dollars and monetary transaction amount associated with the purchase transactions is nine hundred dollars. Therefore, the proportion of the total transaction amount that the sales transactions account for is 10%.

In addition, transaction amount of each transaction may be analyzed. A lower limit for the transaction amount may be set. For example, sales transactions having a transaction amount more than ten dollars may be rendered as credible sales transactions. Additional evaluation factors may be set for the sales transactions.

In existing technology, if a user wants to purchase a commodity through an online transaction, the user normally determines credibility of a seller based on registration information as well as transaction history of the seller prior to conducting the transaction in order to avoid fraud in associated transaction process. However, because a number of fake transactions exist in existing online transaction process and because certain sellers may improve their credibility levels through the fake transactions, a credibility level so obtained is not reliable. However, since users may not be able to discern which credibility information of sellers is true or fake, a number of users may be cheated during a transaction process, thus suffering financial loss.

The scheme provided in the exemplary embodiments combine property information of reference users that have a major influence on credibility of a user to be evaluated, and a proportion of all transactions conducted between the user to be evaluated and the reference users that sales transactions account for to generate a credibility evaluation result for the user to be evaluated. The method provided in the exemplary embodiments greatly improves recognition power of fake credibility and hence security of online transactions.

Presented below is detailed explanation of a more specific exemplary implementation.

In this embodiment, online trading entities who participate in transactions normally register in a certain online trading website. In this embodiment, the online trading entities may be, for example, members of a SSS online trading website. A certain trading entity may obtain an account of the SSS trading website through registration. This trading entity may subsequently conduct an online transaction in the SSS online trading website using the registered account.

Each account that participates in an online transaction possesses certain property parameters. These property parameters are generally stored in a database of the online trading website. Existing technology evaluates credibility of online trading entities mainly through property parameters of respective accounts. For example, upon successfully completion of each transaction, certain existing online trading websites allow both parties of a transaction to evaluate each other with respect to trading conditions. This type of evaluation is called credibility evaluation.

Several concepts are introduced prior to introducing a relatively common existing evaluation system.

Evaluation points: Credibility evaluation may be classified into three categories: “Good”, “Fair”, or “Bad”, each corresponding to a point.

Evaluation scores: Details of a method of calculating evaluation points include: adding a point if “Good,” adding zero point if “Fair,” and deducting a point if “Bad.”

Credibility: Evaluation points of a member are accumulated and displayed in a web page of an account of the member.

Currently, in order to avoid credit speculation between both buying and selling parties, the following provisions are implemented:
1) In each calendar month, evaluation scores that are given between a same set of buyer and seller (which time is counted as the time of corresponding transaction) cannot be more than 6 points. Any evaluation score exceeds this scoring rule will be ignored.
2) If a same set of buyer and seller have conducted multiple Alipay® transactions for a same merchandise within 14 days (calculated from the times of the transactions), only one positive point is counted for multiple positive feedbacks and only one negative point is counted for multiple negative feedbacks.

Although existing credibility evaluation systems set a limit on the total number of evaluations given by a same set of buyer and seller in each month to be six, this type of limit still fails to stop the activities of credit speculation by wild fake transactions. For example, a credit speculator may register multiple accounts which do not increase the cost of the credit speculator.

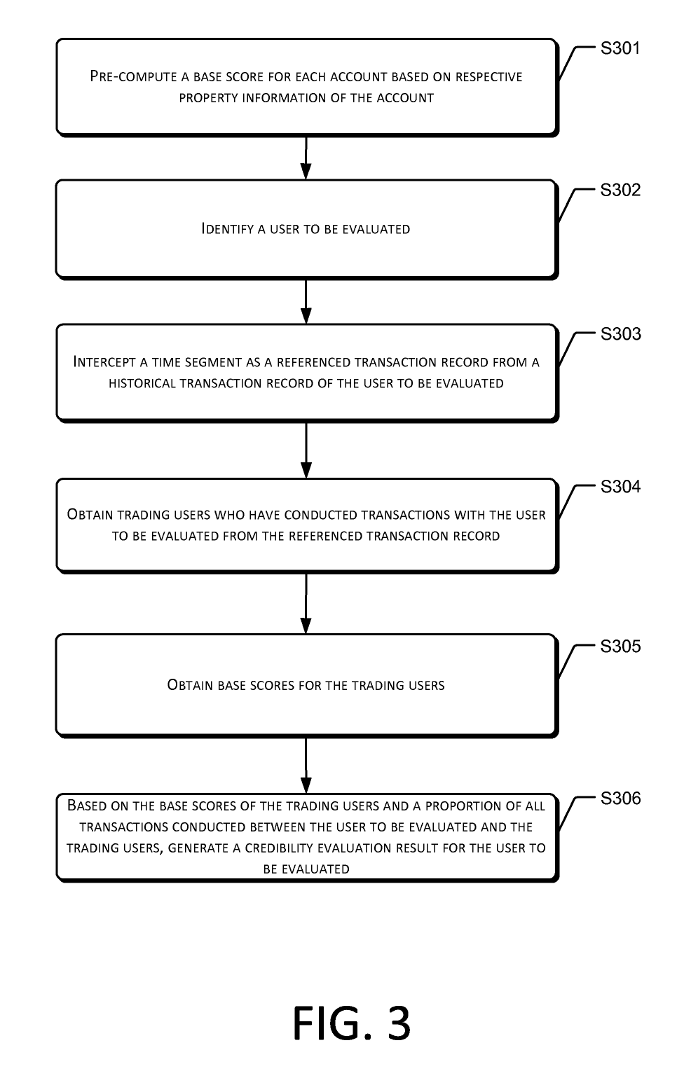

The present disclosure provides a method that is implemented on top of an existing evaluation system. As shown in FIG. 3, the exemplary method includes:

At S301, the method pre-computes a base score associated with each account based on respective property information of each account that is stored in a database of an online trading website.

As described above, property information of each account is stored in a database of an online trading website to which respective account belongs. The property information of an account may include the time of account registration and transaction history, etc. This can be set according to actual needs. The proportion of the base score that is accounted by each parameter of the property information may also be set according to actual needs. This disclosure does not have any limitation thereon.

The following approach may be performed to generate a base score for each account based on respective property information of each account. The approach includes:

At S1, the approach obtains property information of each account from a database of an online trading website.

At S2, the approach sets up a rule for credibility evaluation.

Specifically, different evaluation rules may be set for different scenarios. Examples include which property information to be included for evaluation and what proportion each property accounts for.

S1 and S2 do not have an inevitable logical order therebetween. All property information of each account may first be obtained from the database of the online trading website and a rule for credibility evaluation may subsequently be set according to existing property information. Alternatively, a rule for credibility evaluation may first be set and property information of each account may subsequently be obtained based on the rule.

Predetermined rules may be stored in a rules repository of the online trading website. This rules repository of the online trading website may be set up separately or implemented through the database of the online trading website. The present disclosure does not have any limitation thereon.

At S3, the approach assesses each account based on respective property information of each account in accordance to the rule for credibility evaluation. Through S1-S3, each account is assigned a base score.

At S302, the method identifies a user to be evaluated.

For the sake of description, an account that is registered in a website is used as an illustrative example. Same operations are performed by the system for an account associated with an online transaction.

The exemplary method may identify a user to be evaluated based on his/her base score. For example, a base score threshold may be set. If a base score computed for a certain account is greater than or equal to the base score threshold, this account may be determined to be a candidate of users to be evaluated. Those accounts having a base score less than the base score threshold may be evaluated as unreliable.

Through this screening, multiple candidates of users to be evaluated may be obtained. These candidates of users to be evaluated may be successively evaluated using the exemplary method, or may be selected and evaluated in an ascending order of respective base scores.

At S303, the method intercepts a time segment as a referenced transaction record from a historical transaction record of a user to be evaluated.

Historical transaction record of a user to be evaluated is stored in a database of the online trading website. Upon identifying the user to be evaluated, a referenced transaction record may be found from the database of the online trading website by using the user to be evaluated as an object of search.

Specifically, a time window may be used to intercept a portion of transaction record from the historical transaction record.

At S304, the method obtains trading users which have conducted transactions with the user to be evaluated from the referenced transaction record.

Trading users of the user to be evaluated are references user of the user to be evaluated. The present embodiment introduces a concept of a transaction group. As shown in FIn FIG. 2, X is a user to be evaluated and A, B, C and D are users having conducted transactions with X within a time window. A, B, C and D therefore constitutes a transaction group of X. Whether credibility of the user to be evaluated is good is determined by how many reference users who have high base scores are willing to conduct a transaction with the user to be evaluated.

At S305, the method obtains base scores of the trading users.

At S306, the method generates a credibility evaluation result for the user to be evaluated based on base scores of the reference users and the proportion of all transactions conducted between the user to be evaluated and the reference users that sales transactions account for.

The exemplary method, on the one hand, allows determination of credibility of a certain user to be given to parties who participate in transactions for evaluation, and on the other hand, increases the cost of creating each fake trading account. In existing credibility evaluation system, a number of fake trading accounts are relatively common accounts. These accounts are merely registered, activated, authenticated and involved in a few fake transactions, thus having a relatively low cost. In the exemplary method, if, for example, a rule for credibility evaluation requires an account's transaction group to include more than five accounts having a base score attaining eight hundred points (with a full score being one thousand points for example), the cost for this account will be five times of the original one. Under normal circumstances, the base score of the account used for credit speculation is not high. Moreover, the present embodiment further includes trading directions between the user to be evaluated and the reference users for credibility evaluation. Under normal circumstances, it is easier to conduct a purchase transaction using the account associated with credit speculation whereas conducting a sales transaction is difficult. During evaluation, fake transactions may be removed to a large extent by increasing the control of the transaction amount and the number of transactions associated with sales transactions conducted through the accounts.

For example, in an evaluation process of an account X, the number of transactions obtained in a time window is two hundred and seventy, of which number of purchase transactions conducted by X is ten, and number of sales transactions conducted by X is two hundred and sixty. If these ten purchase transactions involve eight distinct sellers and the two hundred and sixty sales transactions involve two hundred and forty distinct buyers, these two hundred and forty-eight trading users are the reference users of X. If more than 60% of the buyers have a relatively high base score which is more than 700 points (with a full score of 1000 points) or more than 90% of the sellers have a relatively high base score, X may be determined as a reliable member. Understandably, this is merely a simple example. In practical applications, a percentage or an absolute value may be used.

Furthermore, these two hundred and seventy transactions may be analyzed, and an overwhelming majority of the sales transactions may be found to appear to be credible transactions based on transaction amount of the sales transactions. (In a practical application, a reference standard may be set up for the transaction amount. An example includes considering sales transaction having a transaction amount greater than or equal to thirty yuan (RMB) to be credible transaction). As such, the user to be evaluated may be identified to be a user having a relatively high credibility, and be given an evaluation result indicating that the user to be evaluated is reliable.

Conversely, in an evaluation process of an account Y, number of transactions obtained within a time window is 270, of which number of purchase transactions conducted by Y is two hundred and sixty, and number of sales transactions conducted by Y is ten. If the two hundred and sixty purchase transactions involve two hundred and forty distinct sellers and the ten sales transactions involve eight distinct buyers, these two hundred and forty-eight trading users are the reference users of Y. If within these two hundred and forty-eight reference users, base scores of 80% of the reference users are relatively low and less than one hundred points (with a full score of one thousand points), the account Y may be preliminarily suspicious of credit speculation. Further, upon analyzing these two hundred and seventy transactions, if an overwhelming majority of the sales transactions have transaction amounts less than thirty dollars (from the perspective of the transaction amounts of the sales transactions), the exemplary method may directly give an evaluation result indicating that the account Y is unreliable.

On top of evaluating a user to be evaluated based on property information of reference users, the exemplary method further evaluates the user to be evaluated based on a combination of the property information of the references users and a proportion of all transactions conducted between the user to be evaluated and the reference users that sales transactions account for, and generates an evaluation result for the user to be evaluated. The exemplary method greatly improves recognition power of fake credibility and hence security of online transactions.

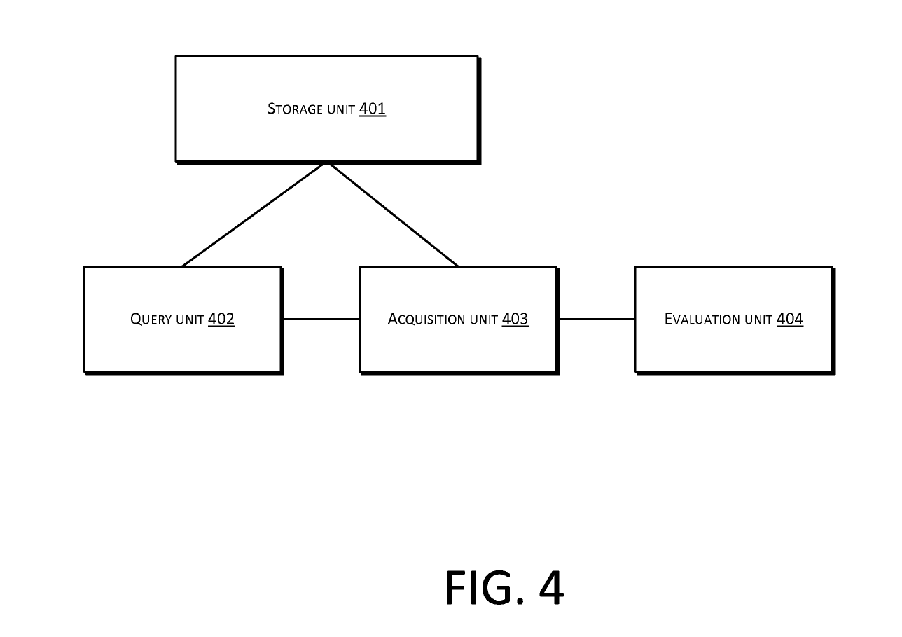

As shown in FIG. 4, the present disclosure further provides an exemplary system of evaluating credibility of an online user, which includes a storage unit 401, configured to store property information of online trading users and a transaction record of each online trading user. In a practical application, the storage unit 401 may be a database of an online trading website. The system also includes a query unit 402, configured to query reference users corresponding to the user to be evaluated based on the user to be evaluated, the reference users including trading users who have conducted transactions with the user to be evaluated and are obtained from a referenced transaction record of the user to be evaluated. Specifically, based on the user to be evaluated, the query unit 402 finds reference users corresponding to the user to be evaluated from the online transaction record of the user to be evaluated that is stored in the storage unit 401.

The system also includes an acquisition unit 403, configured to obtain property information of the reference users. Upon identifying the reference users for the user to be evaluated by the query unit based on the online transaction record, the acquisition unit 403 obtains property information of the reference users from the storage unit. The property information includes information such as the time when a user registered in the trading website, a status of identity verification of the user, number of transactions associated with a registered account of the user, and/or a transaction amount associated with the registered account of the user. The present disclosure does not have any limitations on the details of the property information.

An evaluation unit 404 of the system is configured to generate a credibility evaluation result for the user to be evaluated based on the property information of the reference users and the proportion of all transactions conducted between the user to be evaluated and the reference user for which sales transactions account.

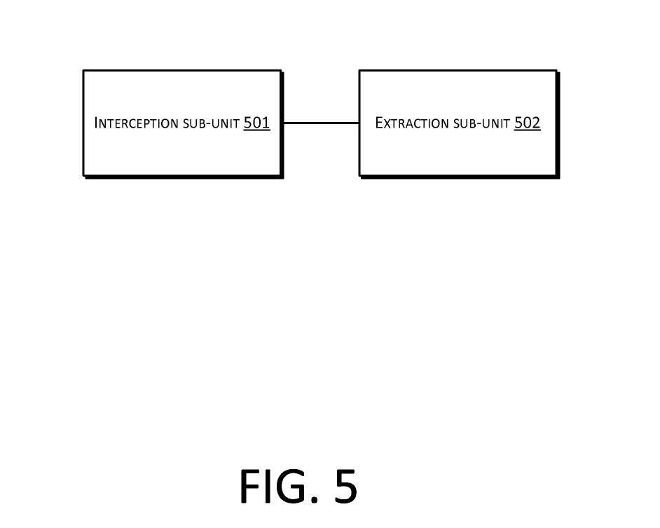

As shown in FIG. 5, the query unit 402 includes an interception sub-unit 501, used for intercepting a time segment as the referenced transaction record from a historical transaction record of the user to be evaluated, and an extraction sub-unit 502, used for obtaining trading users who have conducted transactions with the user to be evaluated from the referenced transaction record, the trading users being the reference users corresponding to the user to be evaluated.

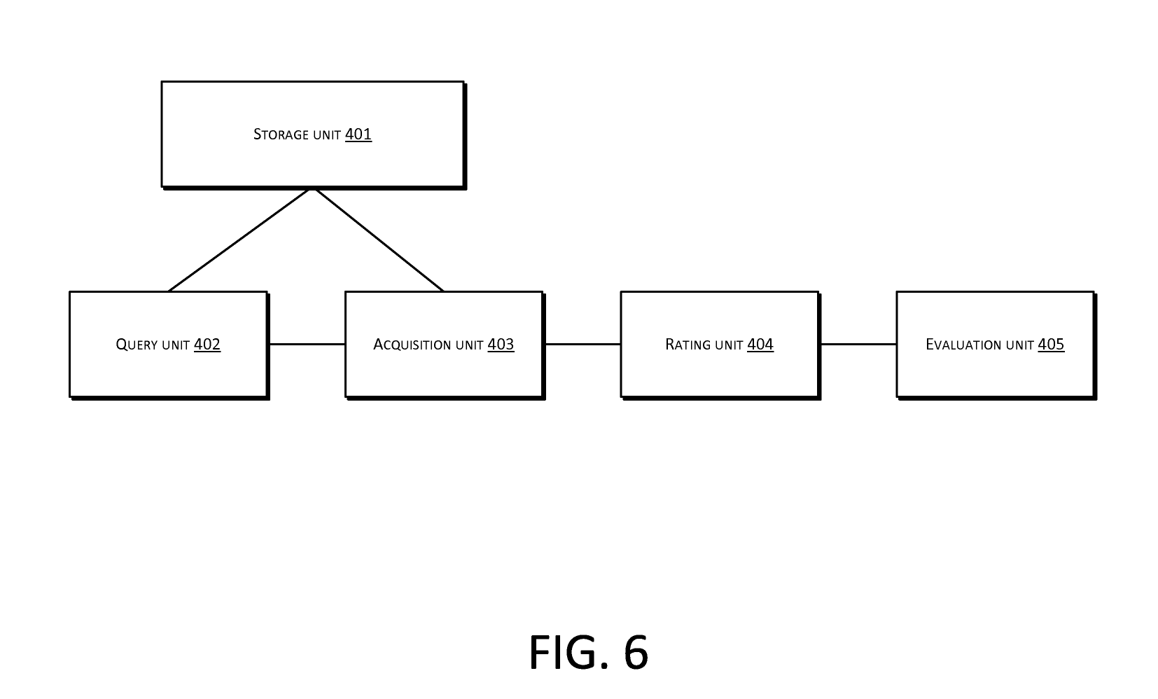

As shown in FIG. 6, the present disclosure provides another exemplary system, of which storage unit 401, query unit 402 and acquisition unit 403 are similar to those in FIG. 4, and therefore not redundantly described herein. Apart from the system in FIG. 4, this system further includes a rating unit 405, used for generating a base score for each reference user based on respective property information of the reference users.

Specifically, the rating unit 405 further includes an information acquisition sub-unit used for obtaining respective property information of each account, a rules setting sub-unit used for setting up a rule for credibility evaluation, and a scoring sub-unit used for generating the base score for each reference user based on the rule for credibility evaluation and respective property information of each reference user.

The evaluation unit 404 is further configured to generate a credibility evaluation result for the user to be evaluated based on the scores of the reference users and the proportion of all the transactions conducted between the user to be evaluated and the reference users that the sales transactions account for.

Although the foregoing embodiments describe using a time window to obtain a time segment from a historical transaction record of a user to be evaluated and extract reference users for evaluating the user to be evaluated from the time segment (i.e., the referenced transaction record), the disclosed method and system may obtain reference users for the user to be evaluated from the entire historical transaction record without using a time window. The reference users for the user to be evaluated may be selected based on the criteria described above.

Additionally or alternatively, the disclosed method and system may use a weighted time window to compute the credibility evaluation result, for example, by giving more weight to feedbacks related to more recent transactions and less weight to feedbacks associated with less recent transactions.

Additionally or alternatively, the disclosed method and system may provide more than one (or different) credibility evaluation results for a user to be evaluated. For example, a buyer, who wants to buy from a seller a product or service that costs one thousand dollars, may not be interested in how well the seller has performed in transactions involving a transaction amount of only one hundred dollars or less. Further, a buyer, who wants to buy an electronic device from a seller, may not be interested in how well the seller has performed in transactions involving a toy, for example. In view of this, the disclosed method and system may divide transaction amounts involved in historical transactions into a predetermined number of ranges. The disclosed method and system may then obtain a credibility evaluation result for each predetermined range. In one embodiment, the credibility evaluation result for a particular range may be computed based on feedbacks associated with transactions (or reference users who have conducted transactions) involving an amount of transaction money within the particular range. In another embodiment, the credibility evaluation result for a particular range may be computed based on feedbacks associated with transactions (or reference users who have conducted transactions) involving an amount of transaction money within and beyond the particular range with equal weighing or higher weighing for the transactions involving a higher amount of transaction money. Additionally, the disclosed method and system may give a lower (or no) weight to transactions involving an amount of transaction money below the particular range.

Additionally or alternatively, the disclosed method and system may provide more than one (i.e., different) credibility evaluation results for a user to be evaluated based on the types of products or services involved in historical transactions. For example, the user to be evaluated (e.g., a seller) may be associated with a number of merchandise or products such as electronics devices (e.g., cameras, televisions, computers, etc.), device accessories (e.g., batteries, screen protectors, etc.), books, etc. In one embodiment, the disclosed method and system may provide a credibility evaluation result for a user to be evaluated for a particular type of product or service. By way of example and not limitation, the disclosed method and system may select reference users who have conducted transactions with the user to be evaluated and whose transactions involved that particular type of product or service. Additionally or alternatively, the disclosed method and system may give a higher weight to feedbacks associated with the transactions involving that particular type of product or service and a lower weight to feedbacks associated with transactions involving a type of product or service that is different from or less similar to that particular type of product or service. Similarity of the products or services may be determined, for example, based on categories of a product catalog in which the products fall or tags associated with the products. The disclosed method and system may display the credibility evaluation result of the user to be evaluated for that particular type of merchandize or product automatically or upon request when a product or service of that particular type is displayed to another user (e.g., a potential buyer), for example. Alternatively, the disclosed method and system may display all credibility evaluation results of the user to be evaluated automatically or upon request when any product or service of the user to be evaluated is displayed to another user.

For the sake of description, the above system has been functionally divided into various units for separate description. Understandably, when the disclosed system is implemented, functions of various units may be implemented in one or more software and/or hardware components.

From the exemplary embodiments described above, one skilled in the art can clearly understand that the disclosed method and system may be implemented using software with essential universal hardware platform. Based on this understanding, the technical scheme of the present disclosure may be implemented in the form of software products which are stored in a non-volatile storage media, e.g., ROM/RAM, disk, or compact disc. The software includes instructions for a computing device (e.g., a personal computer, a server or a networked device) to execute the method described in the exemplary embodiments or certain parts of the exemplary embodiments in the present disclosure.

The various exemplary embodiments are progressively described in the present disclosure. Same or similar portions of the exemplary embodiments can be mutually referenced. Each exemplary embodiment has a different focus than other exemplary embodiments. In particular, the exemplary system has been described in a relatively simple manner because of its fundamental correspondence with the exemplary method. Details thereof can be referred to related portions of the exemplary method.

The disclosed method and system may be used in an environment or in a configuration of universal or specialized computer system(s). Examples include a personal computer, a server computer, a handheld device or a portable device, a tablet device, a multi-processor system, a microprocessor system, a set-top box, programmable consumer electronics, a network PC, a micro-computer, a macro-computer, and a distributed computing environment including any system or device above.

The disclosed method and system can be described in the general context of computer-executable instructions, e.g., program modules. Generally, the program modules can include routines, programs, objects, components, data structures, and the like that perform particular functions or implement particular abstract data types. The disclosed method and system can also be practiced in a distributed computing environment where functions are performed by remote processing devices that are linked through a communication network. In a distributed computing environment, the program modules may be located in local and/or remote computer storage media, including memory storage devices.

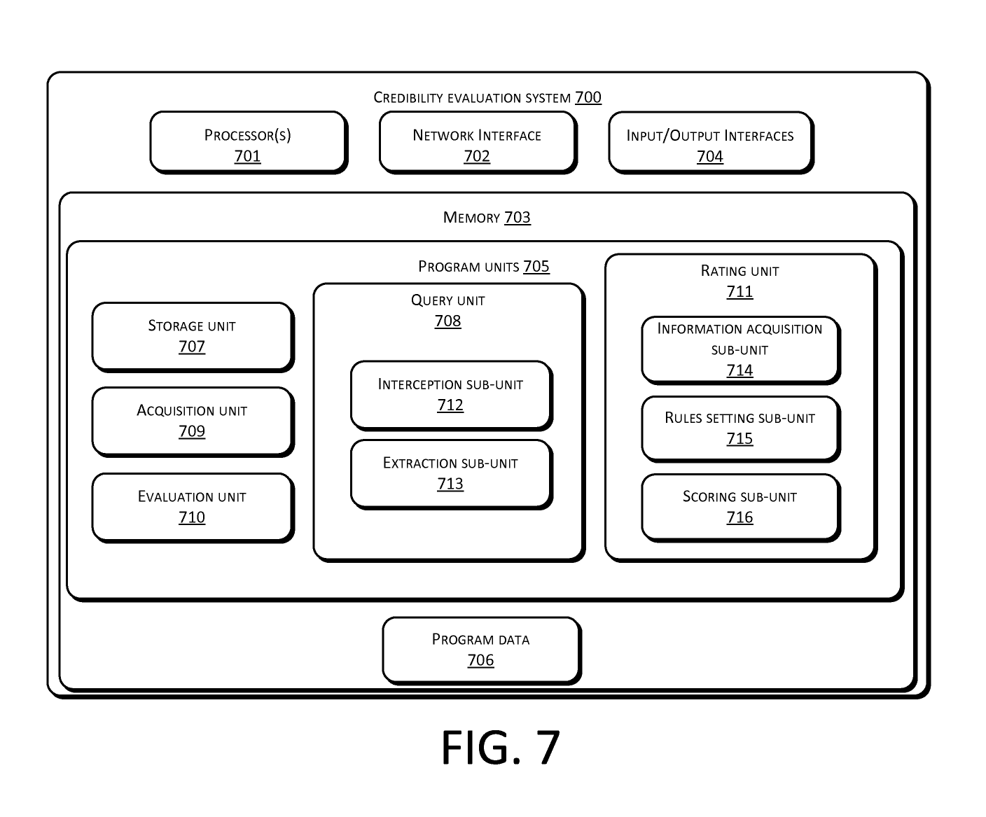

For example, FIG. 7 illustrates an exemplary system 700, such as the system as described above, in more detail. In one embodiment, the system 700 can include, but is not limited to, one or more processors 701, a network interface 702, memory 703, and an input/output interface 704.

The memory 703 may include computer-readable media in the form of volatile memory, such as random-access memory (RAM) and/or non-volatile memory, such as read only memory (ROM) or flash RAM. The memory 703 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 703 may include program units 705 and program data 706. In one embodiment, the program units 705 may include a storage unit 707, a query unit 708, an acquisition unit 709, and an evaluation unit 710. Additionally, in some embodiments, the program units 705 may further include a rating unit 711. In some embodiments, the query unit 708 may further include an interception sub-unit 712 and an extraction sub-unit 713. Additionally or alternatively, the rating unit 711 may include an information acquisition sub-unit 714, a rules setting sub-unit 715 and a scoring sub-unit 716. Details about these program units may be found in the foregoing embodiments described above.

Although exemplary embodiments are used to describe the present disclosure, an ordinary person in the art should understand that the present disclosure can be altered or modified in many different ways without departing from the spirit and the scope of this disclosure. Accordingly, it is intended that the present disclosure covers all modifications and variations which fall within the scope of the claims of the present disclosure and their equivalents.

What we claimed is:

1. A method of evaluating credibility of an online trading user, comprising:
based on a user to be evaluated, querying reference users corresponding to the user to be evaluated, the reference users including trading users who have conducted transactions with the user to be evaluated and are obtained from a referenced transaction record of the user to be evaluated;
obtaining property information of the reference users; and
generating a credibility evaluation result for the user to be evaluated based on the property information of the reference users and a proportion of all transactions conducted between the user to be evaluated and the reference users for which sales transactions account.

2. A method as recited in claim 1, wherein querying reference users corresponding to the user to be evaluated comprises:
obtaining a time segment as the referenced transaction record from a historical transaction record of the user to be evaluated.

3. A method as recited in claim 1, wherein the property information comprises respective times of registration of the users in a trading website, respective status of identity verification of the users, respective numbers of transactions associated with registered accounts of the users and/or respective transaction amounts associated with the registered accounts of the users.

4. A method as recited in claim 3, further comprising generating a base score for each reference user based on respective property information of each reference user.

5. A method as recited in claim 4, wherein generating a credibility evaluation result for the user to be evaluated based on the property information of the reference users and the proportion of all transactions conducted between the user to be evaluated and the reference users that sales transactions account for comprises:
generating the credibility evaluation result for the user to be evaluated based on respective base scores of the reference users and the proportion of all transactions conducted between the user to be evaluated and the reference users for which sales transactions account.

6. A system of evaluating credibility of an online trading user, comprising:
one or more processors and memory storing the following units executable on the one or more processors:
a storage unit, configured to store property information of online trading users and a transaction record of each online trading user;
a query unit, configured to query reference users corresponding to a user to be evaluated based on the user to be evaluated, the reference users including trading users who have conducted transactions with the user to be evaluated and are obtained from a referenced transaction record of the user to be evaluated;
an acquisition unit, configured to obtain property information of the reference users; and
an evaluation unit, configured to generate a credibility evaluation result for the user to be evaluated based on the property information of the reference users and a proportion of all transactions conducted between the user to be evaluated and the reference users that sales transactions account for.

7. A system as recited in claim 6, wherein the query unit comprises:
an interception sub-unit, configured to intercept a time segment as the referenced transaction record from a historical transaction record of the user to be evaluated; and
an extraction sub-unit, configured to obtain trading users who have conducted transactions with the user to be evaluated from the referenced transaction record, the trading users being the reference users corresponding to the user to be evaluated.

8. A system as recited in claim 6, wherein the property information includes respective times of registration of the users in a trading website, respective status of identity verification of the users, respective numbers of transactions associated with registered accounts of the users and/or respective transaction amounts associated with the registered accounts of the users.

9. A system as recited in claim 6, further comprising:
a rating unit, configured to generate a base score for each reference user based on respective property information of each reference user.

10. A system as recited in claim 9, wherein the evaluation unit is further configured to generate the credibility evaluation result for the user to be evaluated based on the scores of the reference users and the proportion of all transactions conducted between the user to be evaluated and the reference users that the sales transactions account for.

11. A system as recited in claim 9, wherein the rating unit comprises an information acquisition sub-unit configured to obtain respective property information of an account associated with each reference user.

12. A system as recited in claim 9, wherein the rating unit comprises a rules setting sub-unit configured to set up a rule for credibility evaluation.

13. A system as recited in claim 12, wherein the rating unit comprises a scoring sub-unit configured to generate the base score for each reference user based on the rule for credibility evaluation and respective property information of each reference user.

14. One or more computer-readable media storing computer-executable instructions that, when executed by one or more processors, cause the one or more processors to perform acts comprising:
based on a user to be evaluated, querying reference users corresponding to the user to be evaluated, the reference users including trading users who have conducted transactions with the user to be evaluated and are obtained from a referenced transaction record of the user to be evaluated;
obtaining property information of the reference users; and
generating a credibility evaluation result for the user to be evaluated based on the property information of the reference users and a proportion of all transactions conducted between the user to be evaluated and the reference users for which sales transactions account.

15. One or more computer-readable media as recited in claim 14, wherein querying reference users corresponding to the user to be evaluated comprises:
obtaining a time segment as the referenced transaction record from a historical transaction record of the user to be evaluated.

16. One or more computer-readable media in claim 14, wherein the property information comprises respective times of registration of the users in a trading website, respective status of identity verification of the users, respective numbers of transactions associated with registered accounts of the users and/or respective transaction amounts associated with the registered accounts of the users.

17. One or more computer-readable media as recited in claim 16, further comprising generating a base score for each reference user based on respective property information of each reference user.

18. One or more computer-readable media as recited in claim 17, wherein generating a credibility evaluation result for the user to be evaluated based on the property information of the reference users and the proportion of all transactions conducted between the user to be evaluated and the reference users that sales transactions account for comprises:
generating the credibility evaluation result for the user to be evaluated based on respective base scores of the reference users and the proportion of all transactions conducted between the user to be evaluated and the reference users for which sales transactions account.

19. One or more computer-readable media as recited in claim 17, further comprising setting up a rule for credibility evaluation.

20. One or more computer-readable media as recited in claim 19, wherein generating the base score for each reference user is further based on the rule for credibility evaluation.
